(19) United States
(12) Patent Application Publication
(10) Pub. No.: US 2006/0092784 A1
(43) Pub. Date: May 4, 2006

(54) Systems and methods for writing data to optical media using plural laser heads

(75) Inventors: Daryl E. Anderson, Corvallis, OR (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/976,522

(22) Filed: Oct. 29, 2004

(51) Int. Cl. G11B 7/00

(52) U.S. Cl. 369/44.38; 369/53.11

(57) ABSTRACT

A method for writing data on optical media includes sequentially outputting the same data to an array of laser heads over time so that the laser heads generate laser beams to write the same data to approximately the same location on the media.

### BACKGROUND

Conventional optical data storage devices are configured to read data from and write data to a removable optical disc. Currently, writable compact discs (CD-R) and re-writable compact discs (CD-RW) are popular formats for personal computers and other like devices. Re-writable digital versatile discs (DVDs), known as DVD-RAMs (random access memory), DVD-R, DVD-R/W, etc., are also becoming more popular as the price of the applicable DVD devices become more affordable.

The process of writing data to an optical disc is often referred to as “burning” the disc, since a beam from a write laser is used to selectively raise the temperature of certain materials within the optical disc such that the materials are altered in some manner. Consequently, features are formed on the disc. These features represent binary data values, i.e., 1's and 0's, which can subsequently be detected (read) using a read laser.

The amount of time required to write data to a disc is proportional to the amount of data to be written. New ways to reduce the amount of time required to write a large amount of data, such as audio and video files, are continually being sought. One way to write data faster is to have the laser beam transverse the media much more rapidly. The chemistry of the optical media requires that the laser beam dwell on the spot to be written for a specific amount of time, at a specific power. More accurately, the media needs to be at a specific temperature for a specific amount of time. Exposing the media to a “hotter” laser for a shorter period of time is not currently seen as an effective solution due to the maximum rotational speed of the motor and the power limit of existing single laser diodes. In the case of label printing, where the written data forms an optically visible label on the medium, one limitation for printing faster is the reaction time for color formation.

### BRIEF DESCRIPTION OF THE DRAWINGS

A more complete understanding of the various methods and apparatuses disclosed herein may be had by reference to the following detailed description when taken in conjunction with the accompanying drawings, wherein:

FIG. 1 is a diagram of an embodiment of a system for writing to media including an array of lasers and components for controlling the laser array;

FIG. 2 shows some examples of media on which data can be written by the system of FIG. 1;

FIG. 3 is a diagram showing operation, according to an embodiment of the invention, of laser heads in the laser array of FIG. 1 over a period of time;

FIG. 4 shows embodiments of laser power, and media temperature versus time profiles, using a single laser head compared to the laser array of FIG. 1;

FIG. 5 shows an embodiment of a media temperature versus time profile that can be achieved by varying the power of the laser heads in the laser array of FIG. 1;

FIG. 6 shows an embodiment of an alignment device that can be used to adjust the orientation of the laser array of FIG. 1 with respect to the media;

FIG. 7 shows an embodiment of a laser array alignment process that can be utilized in the system of FIG. 1;

FIG. 8 shows an embodiment of an optical path for the laser array of FIG. 1;

FIG. 9 shows an example of a diffraction image analysis diagram for the laser array of FIG. 1; and

FIG. 10 shows graphs of the fraction of enclosed energy versus radius from centroid of a spot on the optical media in microns for laser heads spaced at −45, −15, 15, and 45 microns in the laser array of FIG. 1.

### DETAILED DESCRIPTION

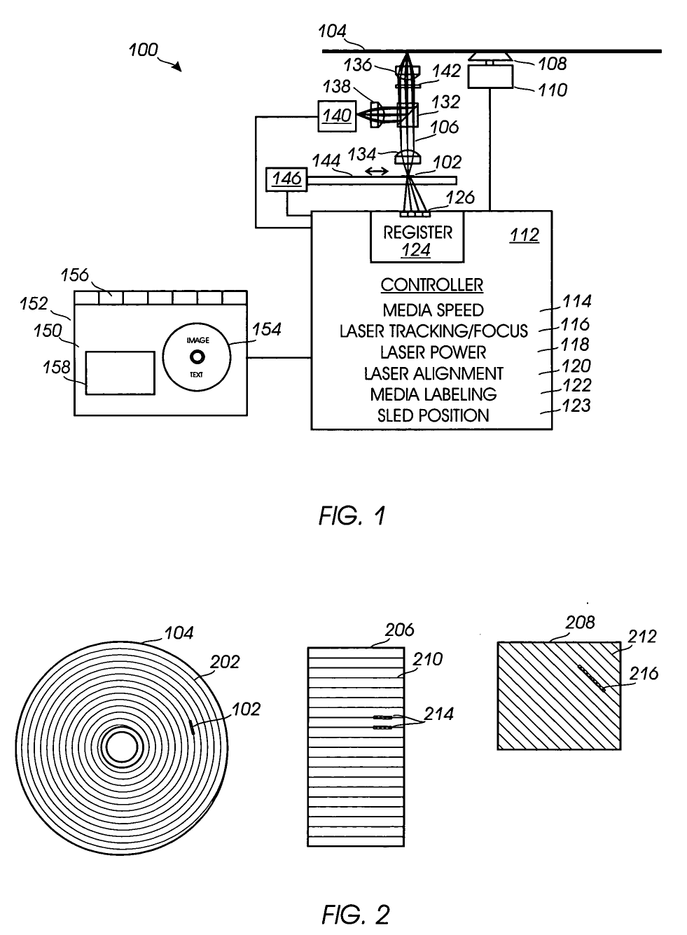

FIG. 1 shows an embodiment of a system 100 including laser array 102 with multiple laser heads configured to write data to optical media 104. The laser heads are configured to generate respective laser beams 106 that are aligned to sequentially write the data to approximately the same location on media 104 as media 104 moves. Laser beams 106 can be used to read from and write to a data side and/or a label side of media 104. Laser array 102 allows media 104 to be moved faster while data is written by laser beams 106. The power of each laser beam 106 can be adjusted independently to write the data to achieve the overall desired temperature versus time profile, thus decreasing the amount of time required to write a given amount of data to media 104.

Laser array 102 may be formed in a variety of ways. For example, a series of lasers on a single substrate can be configured to generate multiple laser beams 106, which are focused as individual spots aligned in series along a track to be written on media 104. The spacing of the spot can be equal to the spacing of spots to be written on media 104. Operating multiple laser heads in laser array 102 at a power equal to the power of a single original laser head allows media 104 to move at a proportional multiple of speed while still maintaining the same amount of time under an effective laser beam of approximate equivalent power to a single laser system. Media 104 written by system 100 will thus be written faster yet respond equivalently compared to that written with single laser systems.

System 100 can also include a mount for holding and moving media 104 relative to laser array 102. In the embodiment shown, media 104 is mounted on spindle 108 to rotate with respect to laser array 102. Spindle 108 is coupled to motor 110, which rotates spindle 108 at a desired speed. Other suitable mechanisms can be used to retain and move media 104 rotationally, linearly, and/or in any other suitable manner with respect to laser array 102. Motor 110 can be coupled to receive a commanded speed from controller 112. The actual speed of spindle 108, or of other media movement mechanisms, can be sensed and provided to a feedback control loop in controller 112 to adjust the speed of movement of media 104, as required.

Controller 112 can include one or more logic instruction modules, such as media speed logic 114, laser tracking/focus logic 116, laser power logic 118, laser alignment logic 120, media labeling logic 122, and sled position logic 123. Logic instructions may be stored on a computer readable medium such as solid state, magnetic, or optical memory, and executed by a processor (not shown) that is internal or external to controller 112. Logic instructions may also be accessed in the form of electronic signals. The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

Controller 112 can also include, or otherwise be coupled to, a mechanism to sequentially supply the data to be written to each laser head in laser array 102. In the embodiment shown, shift register 124 includes buffers 126 that are coupled to supply the data to a respective laser head in laser array 102. Buffers 126 can be configured with communication ports coupled to communicate with a respective laser head. Any suitable type of communication ports can be utilized, such as serial ports, parallel ports, and/or wireless ports. A clocking mechanism can be implemented in register 124 to shift the data through each buffer 126, thereby allowing the data to be output to a respective laser head, one at a time. Other suitable mechanisms for staggering the data output to laser array 102 can be utilized, in addition to, or instead of, register 124 and buffers 126.

Laser array 102 and other components such as beam splitter 132, lenses 134, 136, 138, detector array 140, and wave plate 142 can be mounted on sled 144. Sled motor 146 moves components on sled 144 to position laser beams 106 in a desired location relative to media 104. In the embodiment shown, sled motor 146 advances sled 144 carrying laser array 102 in incremental steps between edges of media 104 under the direction of sled position logic 123.

In some embodiments, a diffraction grating (not shown) can be included in system 100 in the optical path in between laser array 102 and lens 134, or on the surface of beam splitter 132 or wave plate 142 to split laser beams 106 into multiple beams. Separation of laser beams 106 into multiple beams can be accomplished using mechanisms in addition to, or instead of a diffraction grating, such as a holographic element or other suitable technique. Objective lens 136 can be included to focus the split beams onto one or more tracks of media 104. Collimator lens 134 and objective lens 136, 138 can have the same or different optical properties, as required for a particular configuration. Lens 134 can be anamorphic to alter laser beams 106 to the degree desired to create spots on the media with the desired elliptical or circular profile. Wave plate 142 can be included to turn plane-polarized laser beams 106 into circularly polarized light beams 106, thus altering the reflected light's polarization and causing the polarizing beam splitter 132 to direct reflected light into detector array 140.

Laser tracking/focus logic 116 and laser alignment logic 120 can be a closed loop feedback control to accommodate variations in media 104 being used, as well as to accommodate variations in laser array 102. As a result, more accurate and higher quality laser/media interaction can occur. Where laser array 102 was previously used to write data in the form of spots or spots to media 104, laser tracking/focus logic 116 and laser alignment logic 120 may also detect the location, size, and/or shape of the spots. Based on the properties sensed via detector array 140, laser array 102 can be adjusted for future writing on media 104. For instance, the power, exposure time, spot size, alignment, and/or the focus of laser beams 106 may be adjusted.

In some embodiments, laser tracking/focus logic 116 and laser alignment logic 120 in controller 112 can adjust tracking, focus, and alignment of laser heads in laser array 102 by using detector array 140 to sense the laser beams reflected off media 104. Detector array 140 may be physically or optically oriented to optimize image quality and/or other aspects and attributes of system 100. Objective lens 138 can be included to focus the reflected beams into detector array 140. Tracking and focus of individual laser heads can be controlled independently. The alignment of laser array 102 can be adjusted collectively so that spots created by each laser beam 106 are positioned at the desired location, such as a specific track, on media 104.

Media 104 can include one or more sides on which data and/or label information can be written. The label information can be visible to provide information to the user, while the data typically must be read using an appropriate device, such as an optical disc drive. Both the label information and the data are referred to herein as “the data” for simplicity, unless otherwise specified.

Media labeling logic 122 can use information from detector array 140 to distinguish the label portion of media 104 from the data portion of media 104. The data and label portions may be on the same or different sides of media 104. Such sensing can include reading a bar code or other information on media 104, sensing the reflectivity, contrast, gray level, and/or the linearity of the response of the label portion to one or more laser beams 106, and/or other suitable techniques. Media labeling logic 122 can also include logic that converts the data to be written to the label portion of media 104 to an appropriate format.

A user interface 150 can be generated on a display device 152 by media labeling logic 122, or other suitable logic, to allow the user to specify and format label information for media 104. Text and graphics can be displayed on a preview image 154 of media 104 to provide a preview of the appearance of a printed label. When the user is satisfied with the appearance of preview image 154, the label information may be saved. Media labeling logic 122 can be configured to write the label information to the label portion of media 104. Some or all of the label information may be obtained over a network (not shown), such as the Internet. Additionally, information regarding the contents of data written on the data portion of media 104 can be stored after the data is written, and selected by the user or automatically accessed to generate label information. The user can combine artwork or other features with information regarding the contents of data written to the media 104.

One or more toolbars 156 can be provided on user interface 150 to implement desired file handling, and graphics and text formatting features, such as opening and saving files, importing objects and data to be included on the label, and changing attributes or characteristics of selected objects such as color, orientation, and size. An indicator, such as an hourglass (not shown), can also provided on user interface 150 to indicate the amount of time required/remaining to write the label information to media 104. Text to be included on the label can be entered in text box 158, and/or imported from a data file. Other suitable features can be included with user interface 150, in addition to, or instead of, the features described herein.

Controller 112 can be implemented in any suitable processing device(s). A variety of system interfaces and devices may be coupled to controller 112 or other processor including busses, ports, interfaces, disk drives, printers, read-only memory, random access memory, and other devices. Additionally, a variety of user input/output devices may be provided, such as a keyboard, monitor, and a pointer device such as a mouse. An operating system, such as Windows, UNIX or other operating system may operate in controller 112 or other processor, and provide a run-time environment, within which applications such as media labeling logic 122 may be operated.

FIG. 2 shows some examples of media 104, 206, 208 with different shapes, sizes, and track orientations that can be used in system 100 (FIG. 1). Media 104 is shaped as a thin disc with a spiral track 202. Alternatively the media 104 may have a number of concentric tracks. It is anticipated, also, that other suitable shapes and sizes of media, such as rectangular media 206 and square media 208, can be used. For example, system 100 can be configured to create name badges, promotional items, labels with a name, a description of contents, and a date, among other text and graphics items. Further, tracks 210, 212 can be oriented in arcs, in vertical, horizontal, and diagonal lines, or in other suitable orientation that is compatible with operation the configuration of laser array 102. Any suitable type of device can be configured to use laser array 102 and media 104, 206, 208, such as optical disc drives, computers, audio and video players or recorders, consumer electronic devices, and laser printers.

Examples of different configurations of laser array(s) 102, 214, 216 are also shown in FIG. 2 including laser array 102 with four laser heads configured to write data on one track 202 of media 104 at a time; two laser arrays 214 with four laser heads each configured to write the data on more than one track 210 of media 206 at a time; and laser array 216 with eight laser heads configured to write data on one track 212 of media 208 at a time. Note that any number of laser heads can be included in laser arrays 102, 214, 216, subject to space, power, and alignment constraints. For instance, the number of laser heads that can be aligned on a curved track 202 may be more limited than with linear tracks 210, 212.

Media speed logic 114 (FIG. 1) can be configured to vary the speed at which media 104, 206, 204 moves based on the number and configuration of laser heads available to write the data. In some embodiments, system 100 can include one or more laser arrays 102 to write the data to one side of media 104, and another one or more laser arrays 102 configured to write additional data to the other side of the media 104. In such embodiments, the user would not need to flip writable label disc 112 over to write to the other side since a laser array 102 would already be positioned as needed to write the data and/or label information. Controller 112 can further coordinate operation of laser arrays 102 on both sides of media 104 to further reduce the amount of time required to write the data and/or the label information to both sides of media 104.

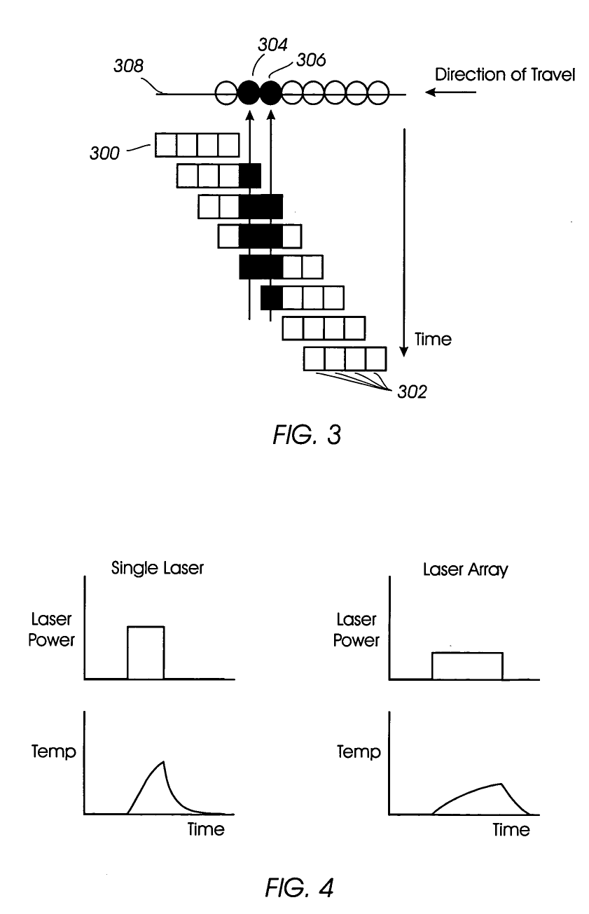

FIG. 3 shows an example of a time history of laser array 300 with four laser heads 302 configured to write data, shown as spots 304, 306 along a track 308 of media moving from right to left. Laser array 300 is shown in staggered incremental positions over time to illustrate the progression of laser heads 302 writing spots 304. As time progresses, each laser head 302 writes spots 304, 306 as the corresponding locations on track 308 are positioned adjacent each laser head 302.

Heating and cooling profiles (temperature versus time) for writing the data to optical media can be critical for obtaining optimal results, especially for media coated with materials that change one or more optical properties such as darkness, contrast, or color when exposed to higher temperatures. For example, some materials may change color based on the rate of cooling, and the performance of erasable media may depend on cooling rates. FIG. 4 shows graphs of laser power and resulting media temperature versus time for a single laser head, and for multiple laser heads in a laser array. A higher laser power is used to write the data with the single laser compared to the laser array. Additionally, the media temperature at locations irradiated laser beam is higher for the single laser compared to the laser array. The laser power and media temperature curves for the laser array extend over a greater amount of time, however, when compared to the single laser curves in order to achieve the optimal temperature versus time profile to write the data on the media. Note that for a given media type the desired temperature versus time profiles will vary depending on the number of laser heads in the laser array. The power profile of each laser head can be controlled independently to achieve the overall desired temperature versus time profile.

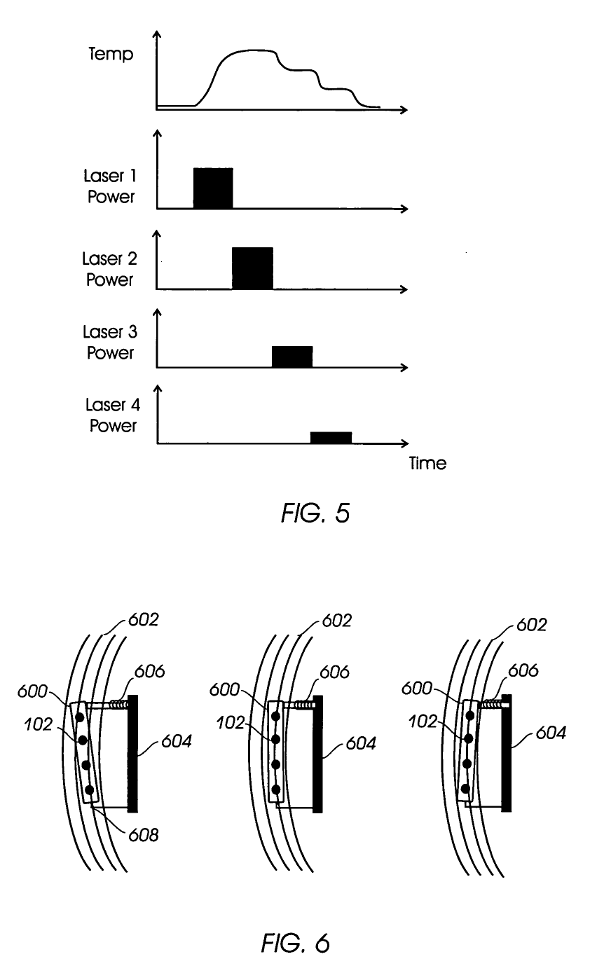

FIG. 5 shows a series of graphs of laser pulse and media temperature versus time for multiple laser heads in a laser array. In the example shown, the laser array includes laser heads 1 through 4, which are controlled to bring a spot on the media quickly to a high temperature, remain at that temperature for a period of time, and then reduce the temperature of the media gradually to ambient temperature. For example, in one embodiment laser power for the first and second laser heads in the array can be set to 100% power as the desired spot on the media moves past the laser heads. The power of the third laser head can be set to 50% as the desired spot on the media moves past the laser head, thus allowing the media to cool. The power of the fourth laser head can be set to 25%, allowing further cooling. Once the spot to be written has passed the fourth laser head, the temperature of the spot on the media returns to ambient. A wide variety of temperature versus time profiles can be achieved by adjusting the power of each laser head over time, independently of the other laser heads.

Referring now to FIGS. 1 and 6, FIG. 6 shows optical assembly 600 in three different orientations relative to media tracks 602 along with an alignment device 604 configured to adjust the orientation of optical assembly 600. Optical assembly 600 can include any suitable components such as laser array 102, beam splitter 132, lenses 134, 136, 138, detector array 140, and/or wave plate 142. In the embodiment shown, alignment device 604 includes a piston 606 at one end and pivot mount 608 at the other. One end of optical assembly 600 is coupled to pivot mount 608 and the other end of laser array 102 is located adjacent to piston 606. Alignment device 604 can be mounted on sled 144 (FIG. 1) so that laser array 102 can be moved to write data on the desired media track 602.

In some embodiments, pivot mount 608 can be a portion of plastic or metal material that flexes when piston 606 exerts a force at the other end of optical assembly 600. Other suitable devices such as a leaf spring, gimbal, and/or hinge, can be used as pivot mount 608. Further, other alternative devices for aligning optical assembly 600 can be implemented, such as a rotary actuator configured to rotate optical assembly 600 to a desired orientation.

Piston 606 can be implemented with a voice coil motor (VCM), a piezoelectric device, and/or any other suitable electrical and/or mechanical device. In the embodiment shown, piston 606 is implemented with a VCM, which is a proportional linear device capable of exerting force proportional to the energizing current. The current in the coil is adjusted so that the resulting magnetic field attracts and repels piston 606 movably mounted in the coil. The piston 606 exerts a force against one end of laser array 102 that is proportional to the current through the VCM. Force exerted by pivot mount 608 on the other end of laser array 102 causes laser array 102 to pivot in the opposite direction when the piston in the VCM is retracted, as shown in FIG. 6. Accordingly, the current through the coil can be adjusted until laser array 102 is properly aligned to write data on one track 602, as shown in the center diagram of FIG. 6.

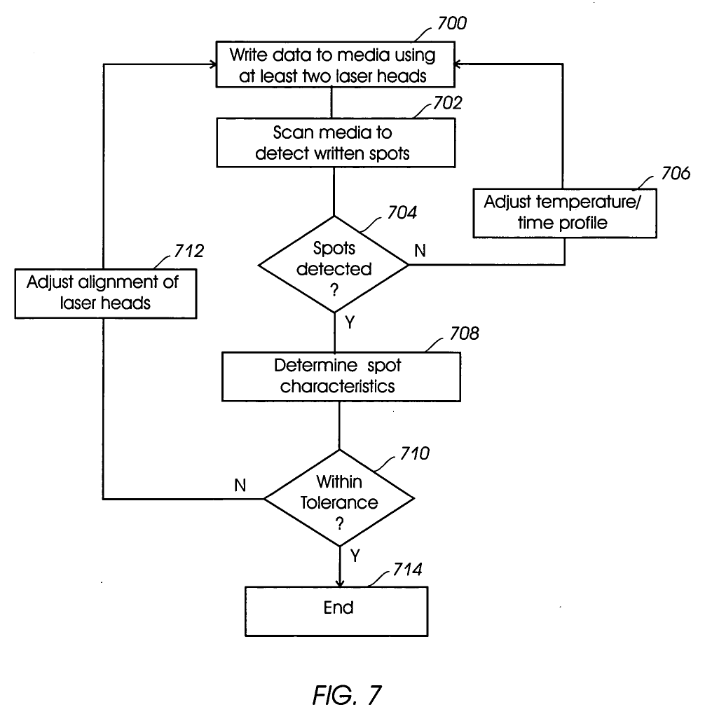

Laser alignment logic 120 in controller 112 can be configured to generate commands to operate the alignment device 604 based on feedback of whether the laser heads are writing the data to the approximate same locations and/or within an allowable space on media 104 (FIG. 1). An embodiment of laser alignment logic 120 is shown in the flow diagram of FIG. 7. Process 700 includes writing the data to the media using at least two of the laser heads, such as the first and last laser heads to span the length of laser array 102. The media is then scanned in process 702 by the same or different laser heads to determine whether the data was written to the approximate same location, and/or within a pre-specified dimensionality on the media within an allowable tolerance. The pre-specified dimensionality can be any suitable measure, such as the width allowed for creating optimal spots on one track of the media. If more than one laser array is used to write the data to two or more tracks in parallel, processes 700 and 702 can be configured to accordingly to determine whether the laser heads are aligned to write data to respective tracks.

Process 704 determines whether the data was detected. If not, process 706 can increase the power of one or more of the laser beams and/or slow the speed at which the media is moved to change the temperature/time profile. Control then transitions from process 706 to process 700 to determine whether the written data can be detected at the new power setting. If process 704 detects the spots, process 708 determines the width of media spanned by the spots and/or whether spots corresponding to the same data were written in approximately the same location. If the spots are not within an allowable tolerance, as determined by process 710, process 712 adjusts the alignment of the laser heads, for example, by operating alignment device 604 (FIG. 6) to change the orientation of laser array 102 relative to tracks 602 on the media. If an adjustment in one direction increases the misalignment, another adjustment can be made in the opposite direction to align optical assembly 600. Control then transitions from process 712 to process 700 to determine whether the new orientation of laser array 102 has improved the alignment of spots on tracks 602.

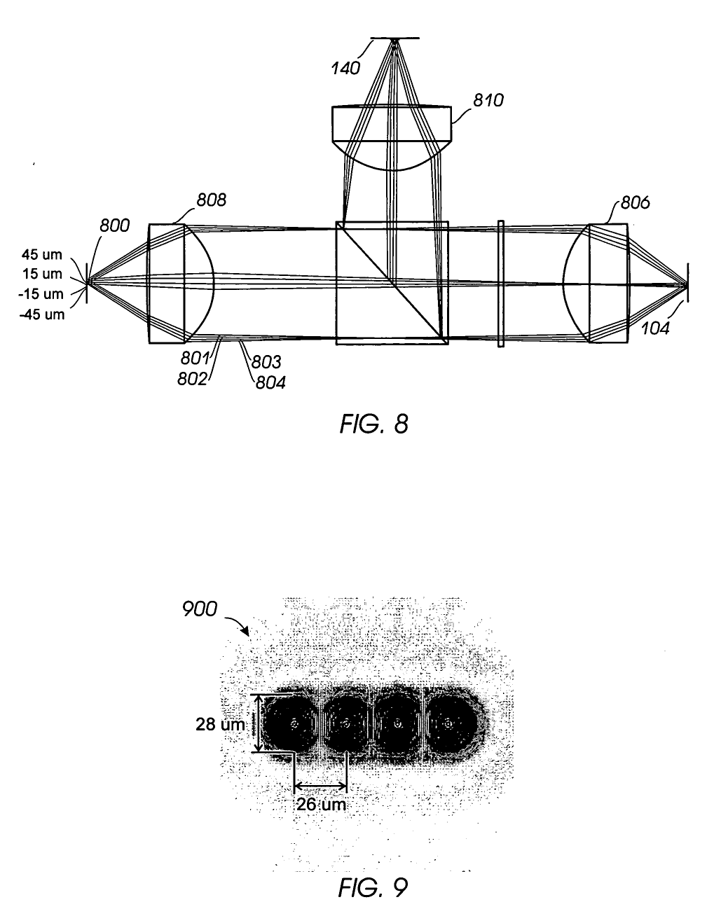

Referring to FIGS. 1 and 8, FIG. 8 shows the full optical path of an embodiment of laser array 800 with four laser heads spaced 30 microns apart. Beams 801 through 804 are emitted from laser heads positioned at −45, −15, 15, and 45 microns in laser array 800. Reflections off media 104 can be sensed by detector array 140. Detector array 140 provides information that is used to adjust the power and/or the exposure time, and/or focus of beams 801 through 804 on media 104 for writing and reading purposes. Thus, as beams 801 through 804 write to or read from media 104, controller 112 can adjust the focus of the laser heads and the alignment of laser array 800 as required. An example of a commercially available optical lens that can be used for collimator lens 808, objective lens 806, and/or sensor array objective lens 810 is Model 350140 by GELTECH, Inc. of Orlando, Fla. Other suitable lenses can be utilized. Note that the embodiment of optical lens 806 shown can accommodate fewer than four laser beams 801 through 804 with acceptable aberration. Other lens configurations can be used to accommodate more than four laser beams 801 through 804. In some configurations, objective lens 806 is positioned at a working distance of 0.83660 millimeters from media 104, even though the best focus distance from media 104 is 0.876286 mm. Positioning objective lens 806 closer than best focus enlarges the spot formed on media 104 so that the spots overlap slightly as shown in FIG. 9. Other suitable distances from media 104 can be used in other configurations.

A Voice Coil Motor can be configured to position objective lens 806 at the correct distance to focus laser beams 802, 804 on media 104. Accordingly, the distance between objective lens 806 and collimator lens 808 will change as objective lens 806 moves to follow media 104. The working distance and optical characteristics of lens 810 are chosen to provide feedback to keep objective lens 806 at a desired distance from media 104 as described above.

Referring to FIGS. 8 and 9, FIG. 9 shows a diffraction image analysis diagram 900 of the pattern made by one embodiment of laser beams 801 through 804 from four laser heads spaced 30 microns apart. The spots in diffraction image analysis diagram 900 indicate the locations where laser beams 106 intersect media 104. The spots are spaced −45, −15, 15, and 45 microns along a track (or direction of movement) of media 104. For the embodiment shown, the average diameter of the area enclosing spots created by the laser heads is 28 microns, which is suitable to achieve printing resolutions of 600 dots per inch or more. Lenses with optical properties that create larger or smaller average diameter areas of spots can be used, depending on the resolution desired. In the embodiment shown, objective lens 806 is defocused to modify the average diameter of the spots or spots made on media 104. Lenses 806, 808 can be designed with optical properties that provide more or less uniformity between spots formed by laser array 800, as desired.

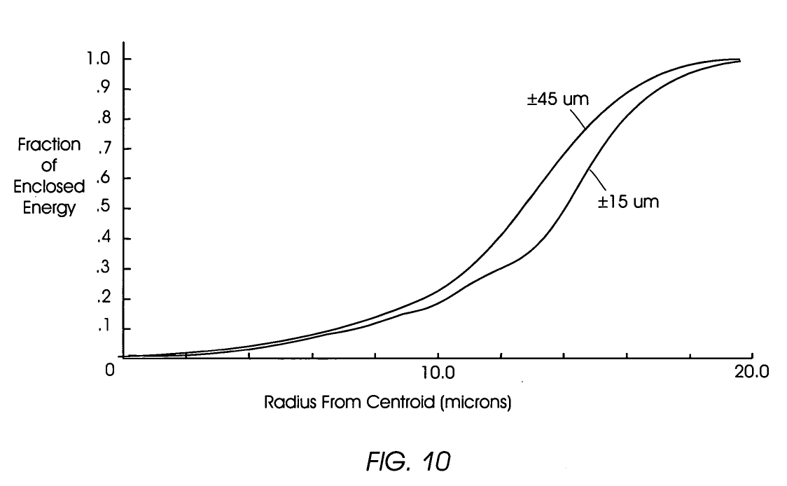

FIG. 10 shows graphs of the fraction of enclosed energy versus radius from centroid of a spot in microns for laser heads in laser array 800 (FIG. 8) spaced at −45, −15, 15, and 45 microns. The fraction of enclosed energy indicates the amount of laser power available to write a spot on media 104. The enclosed energy diagram shows that about 50% of the energy falls within a 14 micron radius circle, which, depending on factors such as laser temperature, media speed, and media type, is often sufficient to create a spot on the media. Note that enclosed energy for the laser heads positioned at ±45 microns within the 14 micron circle is greater than the enclosed energy for laser heads at ±15 microns due to coma. The term “coma” refers to an optical aberration caused by the image of a point being focused at sequentially differing heights, producing a series of asymmetrical spot shapes of increasing size. For the embodiment of the optical system shown in FIG. 8, coma due to lens 806 causes the laser heads positioned at ±45 microns to form smaller diameter light beams 802, 804 than the laser heads positioned at ±15 microns.

The configurations disclosed herein provide examples of embodiments that can be implemented to print labels and relatively low-density data on media 104. It is anticipated that laser arrays 102 with laser heads spaced more closely together, as well as lenses with suitable optical characteristics can be used to write data at higher density.

While the present disclosure describes various embodiments, these embodiments are to be understood as illustrative and do not limit the claim scope. Many variations, modifications, additions and improvements of the described embodiments are possible. For example, media 104 can be held stationary and laser array 102 can be configured to move relative to media 104. Those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

We claim:

1. A system for writing data on media comprising:
a drive for moving the media; and
a plurality of laser heads configured to generate respective laser beams, wherein the laser beams are aligned to sequentially write the data to approximately the same location on the media as the media is moved by the drive.

2. The system as set forth in claim 1, further comprising:
a controller operable to:
control operation of the laser heads to maintain at least one of a specified time profile and a specified temperature profile for writing to the media.

3. The system as set forth in claim 1, further comprising:
a controller operable to:
control the power of the laser beams to maintain a specified time and/or temperature profile for writing to the media.

4. The system as set forth in claim 1, further comprising:
a controller operable to:
control the amount of time the plurality of laser beams write to the same location to maintain a specified time and/or temperature profile for writing to the media.

5. The system as set forth in claim 1, further comprising:
a controller operable to:
sequentially output the data to be written to adjacent ones of the plurality of laser heads.

6. The system as set forth in claim 1, further comprising:
a shift register, wherein the data to be written on the media is input to the shift register, and the data is shifted through the shift register to provide the data to one of the plurality of laser heads at a time.

7. The system as set forth in claim 6,
wherein the register is configured with a plurality of communication ports corresponding to the plurality of laser heads, wherein each of the ports is coupled to communicate with a respective laser head.

8. The system as set forth in claim 7,
wherein the communication ports include at least one of the group consisting of: a serial port, a parallel port, and a wireless port.

9. The system as set forth in claim 1, further comprising:
a second plurality of laser heads configured to generate a respective second set of laser beams that are aligned to sequentially write data to approximately a second same location on the media as the media is moved by the drive.

10. The system as set forth in claim 9, wherein:
the second set of laser beams are aligned to sequentially write data to approximately the same location on a second one of the tracks of the media.

11. The system as set forth in claim 1, further comprising:
a controller operable to:
move the media at a speed based on the number of laser heads.

12. The system as set forth in claim 1,
wherein the drive rotates the media with respect to the laser heads.

13. The system as set forth in claim 1,
wherein the drive moves the media in a linear direction with respect to the laser heads.

14. The system as set forth in claim 1, further comprising:
a controller operable to:
adjust alignment of the laser beams to sequentially write the data on the approximately same location on the media.

15. The system as set forth in claim 1, further comprising:
a controller operable to:
adjust the laser beams to sequentially write the data on the approximately same location on the media based on the speed at which the drive moves the media.

16. The system as set forth in claim 1, further comprising:
a controller operable to:
write the data to the media using at least two of the laser heads, wherein writing the data forms detectable spots on the media; and
scan the media to determine whether the at least two laser heads wrote the data to the approximate same location.

17. The system as set forth in claim 16, further comprising:
a controller operable to:
increase the power of one or more of the laser beams and/or slow the speed at which the media is moved if the data written by the at least two laser heads is not detected.

18. The system as set forth in claim 16, further comprising:
a controller operable to:
determine whether the spots span a prespecified dimension on the media within an allowable tolerance; and
if the spots do not span a prespecified dimension on the media:
(a) adjust alignment of the at least two laser beams;
(b) write the data to the media using at least two of the laser heads, wherein writing the data forms detectable spots on the media;
(c) scan the media to determine whether the dimension of the spots spans more than one track on the media; and
repeat instructions (a) through (c) until the spots span the prespecified width on the media within the allowable tolerance.

19. The system as set forth in claim 1, further comprising:
a controller operable to:
write the data to at least a portion of a track on the media using at least two of the laser heads, wherein writing the data forms detectable spots on the media;
scan the media to determine whether the at least two laser heads wrote the data to the approximate same location;
determine whether the spots span more than the track on the media within an allowable tolerance; and
if the spots span more than the one track on the media:
(a) adjust alignment of the at least two laser beams;
(b) write the data to at least a portion of a track on the media using the at least two laser heads;
(c) scan the media to determine whether the spots span more than the track on the media; and
repeat instructions (a) through (c) until the spots do not span more than the track on the media within the allowable tolerance.

20. The system as set forth in claim 14, further comprising:
an alignment device configured to adjust the orientation of the laser heads.

21. The system as set forth in claim 20, further comprising:
a controller configured to generate commands to operate the alignment device based on feedback of whether the laser heads are writing the data to the approximate same locations on the media.

22. The system as set forth in claim 20, further comprising:
a controller configured to generate commands to operate the alignment device based on feedback of whether the laser heads are writing the data within an allowable space on the media.

23. The system as set forth in claim 20, wherein:
the alignment device is one of the group consisting of: a voice coil motor (VCM), a piezoelectric device, and a mechanical device.

24. The system as set forth in claim 1, further comprising:
a controller operable to:
adjust the power level of at least one of the respective laser beams to be different than the other respective laser beams.

25. The system as set forth in claim 1, wherein:
the power level of the first of the laser beams to write the data to the media is higher than the power level of at least one of the subsequent laser beams to write the data to the media.

26. The system as set forth in claim 1, further comprising:
a controller operable to:
adjust the power level of at least two of the first of the respective laser beams to write the data to the media to be higher than the power level of at least one of the subsequent laser beams to write the data to the media.

27. The system as set forth in claim 1, further comprising:
a controller operable to:
adjust the power level of the laser beams according to a prespecified temperature versus time profile.

28. The system as set forth in claim 1, wherein the plurality of laser heads includes at least four laser heads.

29. The system as set forth in claim 1, wherein the data includes information for writing a label on the media.

30. A system for writing data on optical media, comprising:
a laser array including a plurality of laser heads, wherein the laser heads are fixed in position relative to one another, and the orientation of the laser array is adjustable to align the laser heads relative to the media; and
a controller operable to:
sequentially output the same data to the laser heads so that the laser heads generate a laser beam to write the same data to approximately the same location on the media.

31. The system as set forth in claim 30, further comprising:
a controller operable to:
control the duration and power of the laser beams generated by the laser heads independently from one another to achieve a pre-specified media temperature versus time profile when writing the data.

32. The system as set forth in claim 30, further comprising:
an objective lens positioned between the laser heads and the media, wherein the laser beams are aligned to pass through the objective lens.

33. The system as set forth in claim 30, wherein the laser array is movable relative to the media.

34. The system as set forth in claim 30, further comprising:
a controller operable to:
adjust the alignment of the laser array so that the data is written along one track on the media.

35. The system as set forth in claim 34, further comprising:
a controller operable to:
write the data to the media;
scan the media to determine whether the data was written on one track on the media; and
adjust the alignment of the laser array until the data is written along one track on the media.

36. An apparatus comprising:
laser means operable to generate a plurality of laser beams; and
control means operable to stagger output of data to be written by the laser beams so that the laser beams sequentially write the data to approximately the same location over time.

37. The apparatus of claim 36, further comprising:
control means operable to determine whether at least a portion of the laser beams are writing the data to the approximate same location.

38. The apparatus of claim 36, further comprising:
adjustment means operable to automatically adjust the orientation of the laser means.

39. The apparatus of claim 36, further comprising:
control means operable to control duration of the laser beams to achieve a pre-specified media temperature versus time profile.

40. The apparatus of claim 36, further comprising:
control means operable to control power of the laser beams to achieve a pre-specified media temperature versus time profile.

41. A method for writing data on optical media, comprising:
sequentially outputting the same data to an array of laser heads over time so that the laser heads generate laser beams to write the same data to approximately the same location on the media.

42. The method as set forth in claim 41, wherein the same data comprises data for a label, and wherein writing the same data on the media forms the label on the media.

43. The method of claim 42, wherein the label is formed by a change in an optical property of the same location in response to the laser beams.

44. The method as set forth in claim 41, further comprising:
controlling operation of the laser beams independently from one another to achieve a pre-specified media temperature versus time profile when writing the data.

45. The method as set forth in claim 41, wherein the laser array is movable relative to the media.

46. The method as set forth in claim 41, further comprising:
adjusting the alignment of the laser array so that the data is written in a desired location on the media.

47. The method as set forth in claim 46, further comprising:
scanning the media to determine whether the data was written in a desired location on the media; and
adjusting the alignment of the laser array until the data is written in the desired location on the media.

48. A computer product comprising:
logic instructions operable to sequentially output the same data to an array of laser heads over time to write the same data to approximately the same location on a media.

49. The computer product as set forth in claim 48, further comprising:
logic instructions operable to write a label on the media.

50. The computer product as set forth in claim 48, further comprising:
logic instructions operable to control operation of the laser beams independently from one another to achieve a pre-specified media temperature versus time profile when writing the data.

51. The computer product as set forth in claim 48, wherein the laser array is movable relative to the media.

52. The computer product as set forth in claim 48, further comprising:
logic instructions operable to adjust the alignment of the laser array so that the data is written in a desired location on the media.

53. The computer product as set forth in claim 52, further comprising:
logic instructions operable to:
scan the media to determine whether the data was written in a desired location on the media; and
adjust the alignment of the laser array until the data is written in the desired location on the media.

54. A system for writing a label on media comprising:
a plurality of laser heads configured to generate respective laser beams;
a controller operable to:
provide a signal to write label information for a particular location on the media to each of the laser heads in sequence; and
control the laser beams to write the label information to approximately the same location on the media, wherein the label information is optically visible to a user.

55. The system as set forth in claim 54, further comprising:
media labeling logic operable to distinguish a label portion of the media from a data portion of the media.

56. The system as set forth in claim 55, wherein
the data and label portions may be on the same or different sides of media

57. The system as set forth in claim 55, wherein
the media labeling logic is further operable to interpret encoded information to distinguish the label portion of the media.

58. The system as set forth in claim 55, wherein
the media labeling logic is further operable to sense at least one of the group consisting of: reflectivity, contrast, gray level, and linearity of response of the label portion to one or more of the laser beams.

59. The system as set forth in claim 54, further comprising:
media labeling logic operable to convert the label information to a prespecified format.

60. The system as set forth in claim 54, further comprising:
media labeling logic operable to receive label information via at least one of the group consisting of: a user interface, a computer readable storage file, and the media.
